(19) United States
(12) Patent Application Publication
(10) Pub. No.: US 2021/0226796 A1
(43) Pub. Date: Jul. 22, 2021

(54) COMPUTER-GENERATED HOLOGRAM BASED-GENUINE PRODUCT AUTHENTICATION METHOD, COMPUTER-GENERATED HOLOGRAM BASED-GENUINE PRODUCT AUTHENTICATION SYSTEM, AND DIGITAL HOLOGRAM TAG GENERATOR FOR A COMPUTER-GENERATED HOLOGRAM BASED-GENUINE PRODUCT AUTHENTICATION SYSTEM

(71) Applicant: Future Technology Research Center Inc., Yongin-si (KR)

(72) Inventors: Kwang Ho Ok, Hwaseong-si (KR); Dae Hyun Kim, Seoul (KR)

(73) Assignee: Future Technology Research Center Inc.

(21) Appl. No.: 16/835,207

(22) Filed: Mar. 30, 2020

(30) Foreign Application Priority Data
Jan. 22, 2020 (KR) 10-2020-0008246

(51) Int. Cl. H04L 9/32; G06F 16/53; G06K 7/14; G06K 19/06; G06K 1/12; G06K 9/00; G06F 3/12

(52) U.S. Cl. CPC H04L 9/3226; G06F 16/53; G06K 7/1417; G06K 19/06065; G06K 2009/0059; G06K 9/00577; G06F 3/1206; G06F 3/1297; G06F 3/1247; G06K 1/121

(57) ABSTRACT

The present invention provides a genuine product authentication method, a genuine product authentication system, and a digital hologram tag generator for a genuine product authentication system, which increases a security level of a digital hologram tag. The computer-generated hologram based-genuine product authentication method, the computer-generated hologram based-genuine product authentication system, and the digital hologram tag generator for a computer-generated hologram based-genuine product authentication system are characterized in that a product unique code is set according to a predetermined rule, and the set product unique code is converted into digital hologram and encrypted according to a specific process, and the encrypted code is decrypted through a decryption process same as the encryption process and compared with the unique code stored in the server, thereby preventing illegal copying and allowing consumers to verify the authenticity very conveniently.

### REFERENCE TO RELATED APPLICATIONS

This application claims the priority benefit of Korean Patent Application No. 10-2020-0008246 filed on Jan. 22, 2020, the entire contents of which are incorporated herein by reference.

### FIELD OF THE INVENTION

The present invention relates to a genuine product authentication method, a genuine product authentication system, and a digital hologram tag generator for a genuine product authentication system, which increases a security level of a digital hologram tag. Particularly, the present invention relates to a computer-generated hologram based-genuine product authentication method, a computer-generated hologram based-genuine product authentication system, and a digital hologram tag generator for a computer-generated hologram based-genuine product authentication system, by which a product unique code is set according to a predetermined rule, and the set product unique code is converted into digital hologram and encrypted according to a specific process, and the encrypted code is decrypted through a decryption process same to the encryption process and compared with the unique code stored in the server, thereby preventing illegal copying and allowing consumers to verify the authenticity very conveniently.

### BACKGROUND OF THE INVENTION

A hologram security tag technology is largely divided into an embossed hologram method in which a tag as an interference pattern recorded directly on a recording material or the like using a laser beam is produced in the form of a sticker or the like to visually verify authenticity; and a digital hologram method in which the stored information is analyzed by capturing a tag with a digital interference pattern generated using a computer-generated hologram (CGH) to verify authenticity.

The embossed hologram method is a technique that records a specific pattern on an optical tag and enables direct confirmation of the same by naked eye, and is being widely used in all industrial fields including a resident registration card. However, as the technology gradually develops, it is possible to similarly record and produce tags made of embossed holograms, which results in a situation in which a resident registration card or a bill is forged.

Meanwhile, in the case of the digital hologram method, wavelength information, distance information, and depth information, or the size and number of pixels are important parameters in an encryption process for generating a digital interference pattern. Therefore, since the digital hologram requires the same information in both the encryption and decryption process, it is possible to secure more enhanced security than the embossed hologram method.

However, recently the program code for CGH generation and restoration has been released over the Internet for the popularization of holograms, and therefore anyone can encrypt or decrypt specific codes using the CGH technique. Accordingly, the strength of security of the conventional digital hologram has been gradually weakened. However, since the use of the security technology using the digital hologram is still in use, there is an increasing need for an improved security technique.

### SUMMARY OF THE INVENTION

Accordingly, the present invention has been made keeping in mind the above problems occurring in the prior art, and an objective of the present invention is to provide a computer-generated hologram based-genuine product authentication method, a computer-generated hologram based-genuine product authentication system, and a digital hologram tag generator for a computer-generated hologram based-genuine product authentication system, which make it easier to perform a genuine product authentication for a product using the enhanced security technology.

In order to achieve the above object, a genuine product authentication method with enhanced security level of a digital hologram tag converted by a computer-generated hologram (CGH) according to an aspect of the present invention includes: generating a product unique code and storing the same on a server; generating a specific image file for a text of the product unique code stored in the server and storing the same in association with the product unique code; extracting the specific image file stored in the server in association with the product unique code to convert the same into an original digital hologram security tag using the CGH, in a first CGH encryption step; manipulating pixels in a specific area of the original digital hologram security tag converted through the first CGH encryption to convert the same into a modified digital hologram security tag, in a second CGH encryption step; printing the modified digital hologram security tag converted through the second CGH encryption step to combine the same with the corresponding product; capturing the modified digital hologram security tag of the product using a mobile communication terminal interworking with the server to transmit the same to the server; restoring the pixels of the specific region that is manipulated in the modified digital hologram security tag transmitted through the server to convert the same to the original digital hologram security tag, in a first CGH decryption step; restoring the original digital hologram security tag converted through the first CGH decryption step using the CGH to extract the specific image file, in a second CGH decryption step; extracting unique code text information through OCR processing on the specific image extracted through the second CGH decryption step, to determine whether the unique code text information matches the product unique code stored in the server; and transmitting a result of whether information on the modified digital hologram security tag combined with the product matches information on the corresponding product stored in the server to the mobile communication terminal.

The second CGH encryption step may include any one of randomly shuffling pixels located in a specific row or column in the original digital hologram security tag, or transposing positions of pixels spaced apart by a predetermined distance from each other in the original digital hologram security tag, or rotating pixels of a specific area in the original digital hologram security tag, or rotating pixels of a specific area in the original digital hologram security tag by a predetermined angle clockwise or counterclockwise.

Preferably, the information may be pre-stored in the server so that the second CGH encryption step and the first CGH decryption step are associated with each other for the product.

In order to achieve the above object, a computer-generated hologram based-genuine product authentication system according to an aspect of the present invention includes a security tag generation server 100 sequentially generating a unique code, a unique code image, an original digital hologram security tag, and a modified digital hologram security tag for a product subject to genuine product authentication, storing the unique code, the unique code image, the original digital hologram security tag, and the modified digital hologram security tag in association with product information, and outputting physical or electronic printing of the modified digital hologram security tag through wired/wireless communication with a security tag output device 600 provided in an offline environment; a genuine product authentication management server 200 restoring a security tag capture image received from the outside sequentially to the original digital hologram security tag and the unique code image, and performing an identity comparison process between the unique code image stored in association with the product information and the restored unique code image to determine a product authenticity, and generating information on the product authenticity to transmit the same to the outside; a user mobile terminal 300 possessed by a user to capture the modified digital hologram security tag provided in a product distributed in an offline environment and generate the security tag capture image; and a genuine product verification application 400 installed in the user mobile terminal 300 to manage transmission of the security tag capture image and reception of the product authenticity information by wireless communication with the genuine product authentication management server 200 and to output the product authenticity information.

Preferably, the security tag generation server 100 may include: a product unique code encryption module 110 storing a code generation algorithm 111 that generates the product unique code, a unique code image generation algorithm 112 that generates the unique code image from the unique code, a hologram security tag generation algorithm 113 that generates the original digital hologram security tag from the unique code image, and a hologram security tag modification algorithm 114 that converts the original digital hologram security tag into the modified digital hologram security tag; a unique code-security tag information DB 120 storing the unique code, the unique code image, the original digital hologram security tag, and the modified digital hologram security tag in association with the product information; a generation server communication module 130 outputting a physical or electronic printing of the modified digital hologram security tag via wired/wireless communication with the security tag output device 600 provided in an offline environment, or performing a synchronization process for information stored in the unique code-security tag information DB 120 via wired/wireless communication with the genuine product authentication management server 200; and a communication security module 140 controlling the activation of the generation server communication module 130 to allow the generation server communication module 130 to communicate with the outside only by a communication function activation signal of an administrator account and allow the generation server communication module 130 not to communicate with the outside at a time other than a communication function activation time interval set by the administrator account, and activating a firewall function when the generation server communication module 130 communicates with the outside.

Preferably, the genuine product authentication management server 200 may include: a security tag capture image input module 210 receiving the security tag capture image received from the genuine product verification application 400 of the user mobile terminal 300, and extracting the modified digital hologram security tag included in the security tag capture image; a product unique code decryption module 220 storing a hologram security tag restoration algorithm 221 that restores the modified digital hologram security tag transmitted from the captured image input module 210 to the original digital hologram security tag, a unique code image restoration algorithm 222 that restores the original digital hologram security tag to a unique code image, and a unique code extraction algorithm 223 that extracts the unique code text information as a key value by performing OCR processing on the unique code image; a unique code information synchronization DB 230 storing the unique code associated with the product information in synchronization with the unique code-security tag information DB 120 of the security tag generation server 100; an authenticity determination module 240 determining information indicating whether the product is genuine or not by determining whether the unique code text information transmitted from the product unique code decryption module 220 matches the product unique code stored in the unique code information synchronization DB 230, the product authenticity information including genuine product authentication information generated when the unique code text information matches the product unique code of the stored in the unique code information synchronization DB 230, and genuine product non-authentication information generated when the unique code text information does not match the product unique code stored in the unique code information synchronization DB 230; and a product authenticity information transmission module 250 receiving product authenticity information from the authenticity determination module 240 and transmits the same to the genuine product verification application 400 of the user mobile terminal 300.

Preferably, the hologram security tag modification algorithm 114 of the product unique code encryption module 110 may include at least one algorithm selected from: a shuffle based modification algorithm 1141 generating the modified digital hologram security tag by randomly shuffling pixels located in a specific row or column in the original digital hologram security tag consisting of multiple pixels; a transposition based modification algorithm 1142 generating the modified digital hologram security tag by symmetrically transposing positions of pixels spaced apart from each other by a predetermined distance in the original digital hologram security tag; a rotation based modification algorithm 1143 generating a modified digital hologram security tag by rotating pixels of a specific area in the original digital hologram security tag; and a rolling based modification algorithm 1144 generating a modified digital hologram security tag by rotating pixels in a specific area by a predetermined angle clockwise or counterclockwise in the original digital hologram security tag, and

the hologram security tag restoration algorithm 221 of the product unique code decryption module 220 includes at least one of: a shuffle based restoration algorithm 2211 restoring the original digital hologram security tag from the modified digital hologram security tag by performing an information processing process of the shuffle based modification algorithm 1141 in reverse order thereof; a transposition based restoration algorithm 2212 restoring the original digital hologram security tag from the modified digital hologram security tag by performing an information processing process of the transposition based modification algorithm 1142 in reverse order thereof; a rotation based restoration algorithm 2213 restoring the original digital hologram security tag from the modified digital hologram security tag by performing an information processing process of the rotation based modification algorithm 1143 in reverse order thereof; and a rolling based restoration algorithm 2214 restoring the original digital hologram security tag from the modified digital hologram security tag by performing an information processing process of the rolling based modification algorithm 1144 in reverse order thereof.

In order to achieve the above object, a digital hologram tag generator for a computer-generated hologram based-genuine product authentication system according to an aspect of the present invention includes: a unique code generation unit 510 provided with a code generation algorithm 111 to generate a unique code for a product that is subject to genuine product authentication; a unique code image generation unit 520 provided with a unique code image generation algorithm 112 to generate a unique code image for the unique code; an original digital hologram security tag generation unit 530 provided with a hologram security tag generation algorithm 113 to generate an original digital hologram security tag from the unique code image; and a modified digital hologram security tag generation unit 540 provided with a hologram security tag modification algorithm 114 to convert the original digital hologram security tag into a modified digital hologram security tag,

wherein the hologram security tag modification algorithm 114 including at least one of: a shuffle based modification algorithm 1141 generating the modified digital hologram security tag by randomly shuffling pixels located in a specific row or column in the original digital hologram security tag consisting of multiple pixels; a transposition based modification algorithm 1142 generating the modified digital hologram security tag by symmetrically transposing positions of pixels spaced apart from each other by a predetermined distance in the original digital hologram security tag; a rotation based modification algorithm 1143 generating the modified digital hologram security tag by rotating pixels of a specific area in the original digital hologram security tag; and a rolling based modification algorithm 1144 generating the modified digital hologram security tag by rolling pixels in a specific area by a predetermined angle clockwise or counterclockwise in the original digital hologram security tag.

According to the present invention, the product unique code stored in the server is set according to a predetermined rule, and the set product unique code is converted into the digital hologram tag in the manipulation way of encrypting the same into digital hologram, so that when a consumer captures the digital hologram tag using his/her mobile communication terminal and then transmits the same to the server, he/she can be notified of whether the digital hologram tag is the same as the stored unique code through a decryption process same as the predetermined rule, thereby preventing illegal copying and allowing consumers to verify the authenticity very conveniently by making the most of advantages of the digital hologram security technology in the related art.

### BRIEF DESCRIPTION OF THE DRAWINGS

The above and other objects, features, and other advantages of the present invention will be more clearly understood from the following detailed description when taken in conjunction with the accompanying drawings, in which:

FIG. 1 is an exemplary diagram showing an image of a product unique code according to the present invention;

FIG. 2 is an exemplary diagram showing an original digital hologram security tag obtained by encrypting a product unique code image shown in FIG. 1 using first computer-generated hologram (CGH) encryption;

FIGS. 3A to 3D are schematic diagrams showing a method of encrypting the original digital hologram security tag disclosed in FIG. 2 using second CGH encryption;

FIG. 4 is an exemplary diagram showing a modified digital hologram security tag printed after being encrypted through second CGH encryption;

FIG. 5 is an example diagram showing digital information of a modified digital hologram security tag captured by a mobile communication terminal;

FIG. 6A to 6D are schematic diagrams showing a method of decrypting a modified digital hologram security tag using first CGH decryption;

FIG. 7 is an exemplary diagram showing an original digital hologram security tag decrypted using first CGH decryption;

FIG. 8 is an exemplary diagram showing a product unique code image decrypted using second CGH decryption;

FIG. 9 is a configuration block diagram showing a computer-generated hologram based-genuine product authentication system according to an embodiment of the present invention;

FIG. 10 is a configuration block diagram showing a security tag generation server and a genuine product authentication management server according to an embodiment of the present invention;

FIG. 11 is a configuration block diagram showing a product unique code encryption module according to an embodiment of the present invention;

FIG. 12 is a block diagram showing a product unique code decryption module according to an embodiment of the present invention; and

FIG. 13 is a configuration block diagram illustrating a digital hologram tag generator for a computer-generated hologram based-genuine product authentication system according to an embodiment of the present invention.

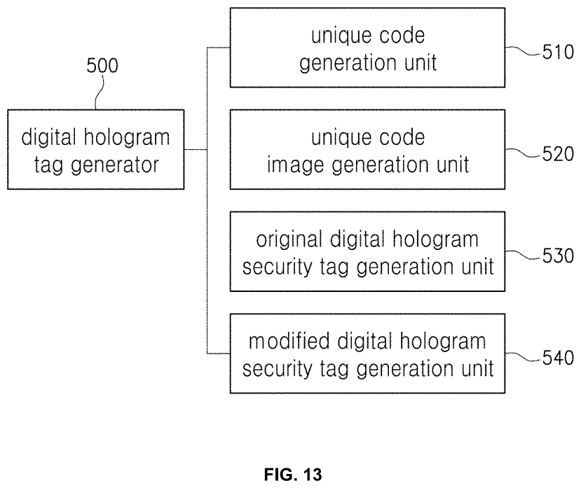

### DETAILED DESCRIPTION OF THE INVENTION

Preferred embodiments according to the present invention will be described in detail with reference to the accompanying drawings, in which the embodiments of the present invention are not directly related to the technical features of the present invention, or generally in the technical field to which the present invention belongs. The detailed description of the matters apparent to those with knowledge of the present invention will be omitted.

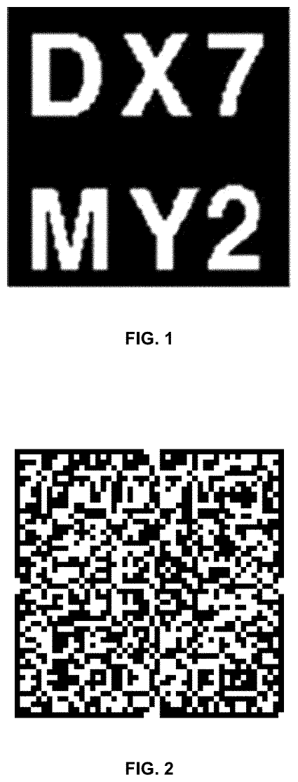

First, a product unique code is generated and stored in the server. The product unique code may consist of a product recognition code and a product serial number. The product recognition code may be assigned to each product family having different characteristics, and the serial number is an identification number in the same product family. FIG. 1 shows an example showing an image of a product unique code composed of a combination of six letters and numbers.

When the product unique code is assigned and stored in the server, the stored product unique code is extracted from the server so that an image file for a text of the unique code is generated, such as bmp or png, and saved in the server in association with the product unique code.

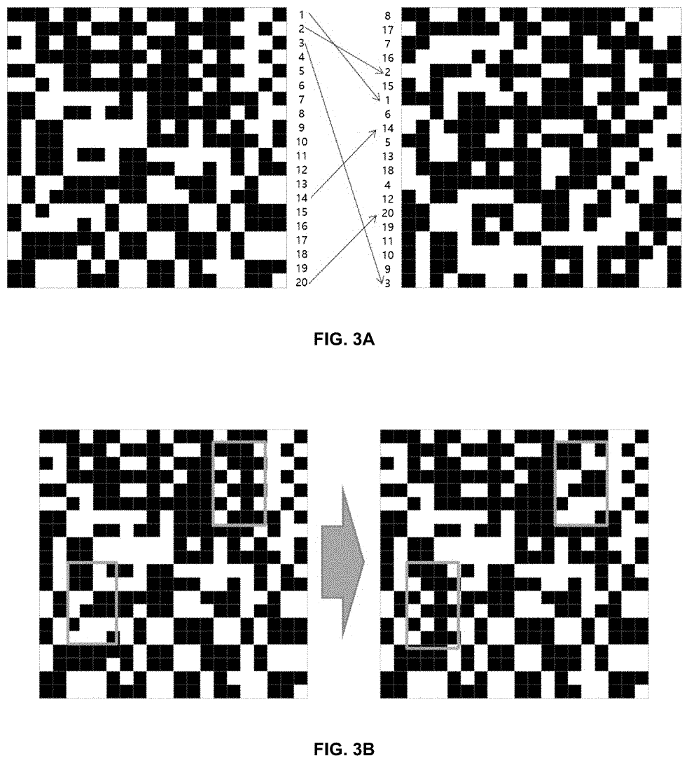

When the generated image file is stored in the server in association with the product unique code, a first CGH encryption step is performed in which a specific image for the product is converted into the original digital hologram security tag using computer-generated hologram (CGH). FIG. 2 is an exemplary diagram showing an original digital hologram security tag obtained by encrypting a text of a specific image shown in FIG. 1 through the first CGH encryption step.

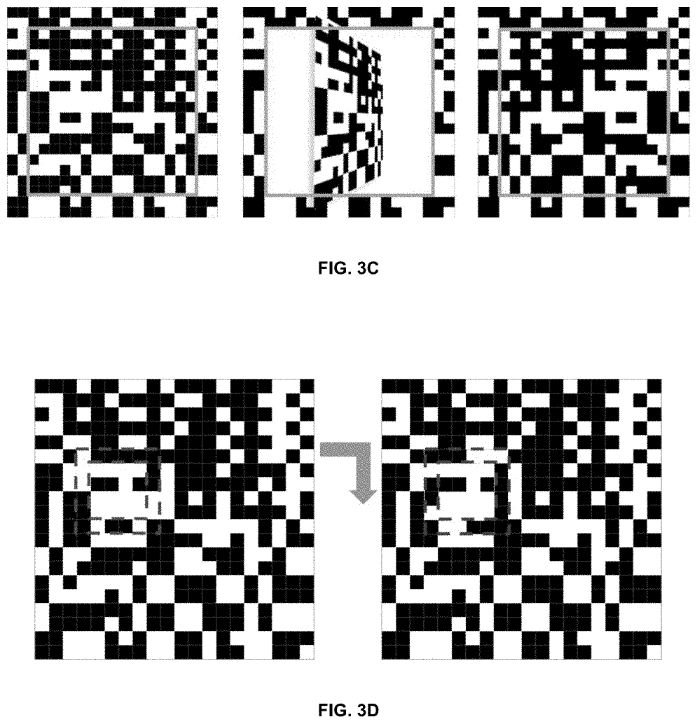

The CGH used in the encryption step according to the present invention may be one of programs commonly used in the related art. When a specific image file is converted into an original digital hologram security tag through the first CGH encryption, the image file is composed of a combination of a plurality of pixels, as shown in FIGS. 3A to 3D which are enlarged views of a portion of the tag.

When the first CGH encryption step for the image of the product is completed, the second CGH encryption step is followed. The second CGH encryption step according to the present invention may be performed in such a manner as to manipulate pixels of a specific region of the original digital hologram security tag generated for the corresponding specific image to convert the original digital hologram security tag into a modified digital hologram security tag.

Since the original digital hologram security tag may be restored using CGH generation and restoration programs published over the Internet, it is preferable to manipulate a series of pixels on a per line basis or on a per area basis to block a possibility of restoration using the restoration programs, whereby the security stability of the hologram security tag may be maximized.

Herein, the manipulation refers to one of following methods of randomly shuffling specific pixels, transposing specific pixels symmetrically, rotating specific pixels, and rolling specific pixels, among multiple pixels that make up a security tag, which will be described hereinafter.

First, pixels located in a specific row or column of the original digital hologram security tag generated through the first CGH encryption step are randomly shuffled. FIG. 3A shows an example of a modified digital hologram security tag made by replacing pixels of each row with pixels of other row in the original digital hologram security tag consisting of 20 pixels each in width and length.

Secondly, positions of pixels spaced apart from each other by a predetermined distance are symmetrically transposed in the original digital hologram security tag made through the first CGH encryption step. When dividing the original digital hologram security tag consisting of 20 pixels each in width and length into four quadrants, FIG. 3B illustrates an example of a modified digital hologram security tag made by transposing specific pixels of the first quadrant and specific pixels of the third quadrant with each other.

Thirdly, pixels in a specific area of the original digital hologram security tag made through the first CGH encryption step are rotated. The rotation may be any one of left and right rotation, up and down rotation, diagonal rotation, and rotation of a portion. FIG. 3c shows an example of a modified digital hologram security tag made by left-and-right rotating the pixels located at the center of the original digital hologram security tag consisting of 20 pixels each in width and length.

Fourthly, pixels in a specific area of the original digital hologram security tag made through the first CGH encryption step are rolled by a predetermined angle. The rolling may be performed by rolling the pixels clockwise or counterclockwise. FIG. 3D shows an example of a modified digital hologram security tag made by rolling pixels positioned between an outer rectangle and an inner rectangle by 90 degrees clockwise in the original digital hologram security tag consisting of 20 pixels each in width and length.

In the second CGH encryption step, the manipulation of pixels in a specific area must be performed according to a predetermined rule in advance. This is because each of the encryption process and the decryption process need to be performed according to the same rule. Therefore, the manipulation method for each specific product should be stored in the server in advance.

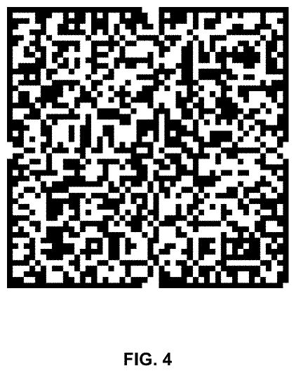

When the original digital hologram security tag for the specific image, which is associated with the product unique code, is converted into the modified digital hologram security tag through the second CGH encryption step according to the present invention, the modified digital hologram security tag is printed and combined with the corresponding product. FIG. 4 shows an example of the modified digital hologram security tag that is printed.

The modified digital hologram security tag may be printed directly on the product itself, and the printing may be variously changed, such as attaching the modified digital hologram security tag printed on a separate printing paper to the product or enclosing the same with the product. Thereafter, the corresponding product on which the modified digital hologram security tag is printed is handed over to consumers through various distribution processes.

When the product combined with the modified digital hologram security tag is handed over to a consumer, the consumer captures the modified digital hologram security tag printed on the product itself or enclosed with the product using a camera installed on the mobile communication terminal.

Herein, the mobile communication terminal should be interworked with a server in which the product unique code and a specific image associated with the same are stored. Interworking between the mobile communication terminal and the server having the unique code and the image stored may be accomplished by a separate application. It is sufficient as long as the application may exchange digital information with the server using a camera installed in the mobile communication terminal.

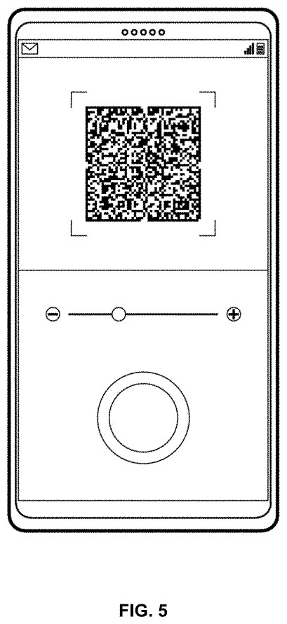

When the modified digital hologram security tag is captured by the camera installed in the mobile communication terminal, the application transmits the digital information to the server. FIG. 5 is an exemplary diagram showing digital information related to the modified digital hologram security tag, which is captured by the mobile communication terminal and transmitted to a server.

When the digital information about the modified digital hologram security tag is transmitted through the application of the mobile communication terminal, the server performs a first CGH decryption step in which the transmitted digital information is decrypted. Since the digital information transmitted to the server is for the modified digital hologram security tag, when the manipulated image is decrypted, the original digital hologram is restored.

That is, each of the modified digital hologram security tags manipulated in each of FIGS. 3A to 3D is restored to each of the original digital hologram security tags, which are tags before being manipulated, through the reverse process thereof.

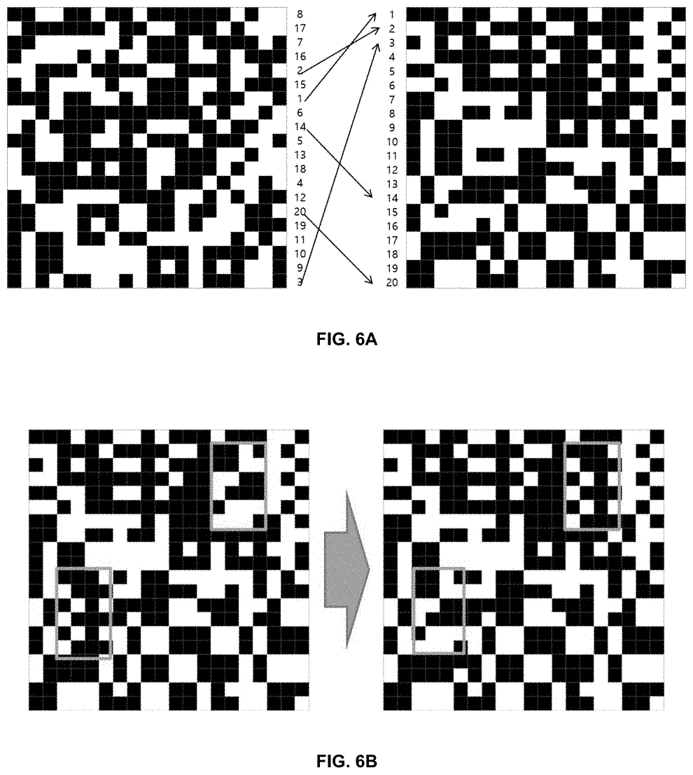

More specifically, when the modified digital hologram security tag is manipulated in such a manner that pixels in each row are shuffled with random row positions as shown in FIG. 3A, the pixels are returned to the original row positions as shown in FIG. 6A. When the modified digital hologram security tag is manipulated in such a manner that pixels of a specific area are symmetrically transposed as shown in FIG. 3B, the pixels are moved again to return to the original positions as shown in 6B.

In addition, when the modified digital hologram security tag is manipulated in such a manner that pixels in a specific area are rotated as shown in FIG. 3C, the pixels are rotated left and right to return to the original position as shown in FIG. 6C. When the modified digital hologram security tag is manipulated in such a manner that pixels in a specific area are rolled by 90 degrees clockwise as shown in FIG. 3D, the pixels are rolled by 90 degrees counterclockwise as shown in FIG. 6d to return to the original positions.

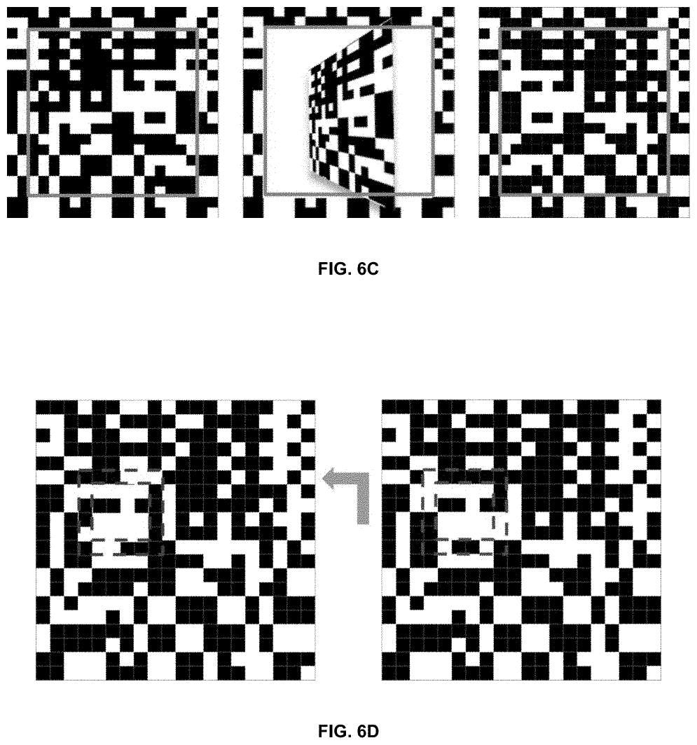

It is needless to say that each of these operations should follow the original predetermined rules as described above, and the predetermined rules should be pre-stored in the server. FIG. 7 illustrates an example in which such a decryption operation is completed.

When the first CGH decryption step for the modified digital hologram security tag is completed and the original digital hologram security tag is obtained, the second CGH decryption step is followed. The second CGH decryption step is to extract a specific image of the product from the original digital hologram security tag obtained through the first CGH decryption step.

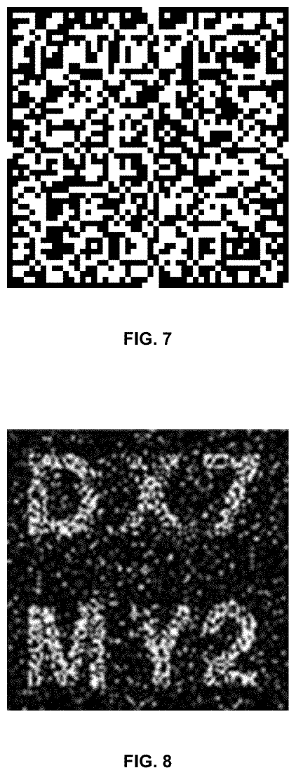

The second CGH decryption step corresponds to the first CGH encryption step, and may be simply performed using the same CGH to that used in the first CGH encryption step. FIG. 8 shows an example of a specific image corresponding to the product unique code extracted through the second CGH decryption step.

When the specific image is extracted through the second CGH decryption step using CGH, the unique code text information is extracted by performing processing, such as OCR, on the extracted specific image, and it is determined whether the unique code text information matches the product unique code stored in the server.

As shown in each of FIGS. 1 and 8, when the extracted unique code matches the unique code of the product stored in the server, the server transmits the result to the mobile communication terminal, so that the consumer may easily check whether the corresponding product is genuine according to the transmitted result.

In the case of converting an image of the product unique code into a digital hologram using CGH commonly known, this operation may be performed on a per pixel basis. As shown in FIGS. 3A to 3C, each of the horizontal and vertical pixels consists of 20 pixels, but may consist of 200 pixels or more.

Assuming that each of the horizontal and vertical directions consists of 200 pixels and the manipulation is performed as shown in FIG. 3A, since the number of cases of mathematical restoration is the factorial of 200 (7.8×10364), it is not possible to perform illegal copying until knowing the predetermined rules in advance.

Therefore, in the case that the original digital hologram security tag consisting of appropriate pixels according to the present invention is manipulated to generate a modified digital hologram security tag, when a user does not know the predetermined rules in advance, the user never knows information about the product unique code, thereby making it impossible to illegally copy the unique code.

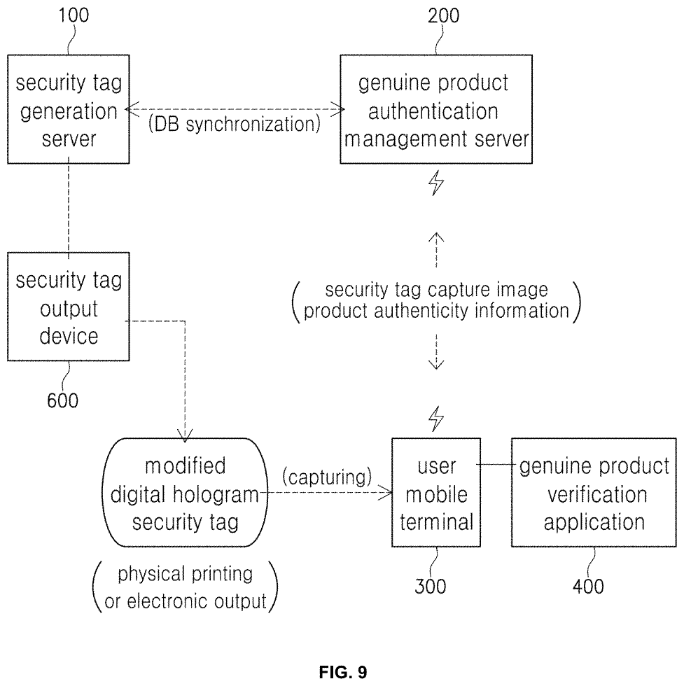

Meanwhile, the computer-generated hologram based-genuine product authentication system according to an embodiment of the present invention is configured to include a security tag generation server 100, a genuine product authentication management server 200, a user mobile terminal 300, an genuine product verification application 400, as shown in FIG. 9. Here, the security tag generation server 100 and the genuine product authentication management server 200 are preferably provided separately in consideration of the information processing load. Of course, the security tag generation server 100 and the genuine product authentication management server 200 may be operated as an integrated server in environmental conditions such as a small service environment.

The security tag generation server 100 sequentially generates a unique code, a unique code image, an original digital hologram security tag, and a modified digital hologram security tag for a product that is subject to genuine product authentication, and stores the unique code, the unique code image, the original digital hologram security tag, and the modified digital hologram security tag in association with the product information. In addition, the security tag generation server 100 outputs physical or electronic printing of the modified digital hologram security tag through wired/wireless communication with a security tag output device 600 in an offline environment.

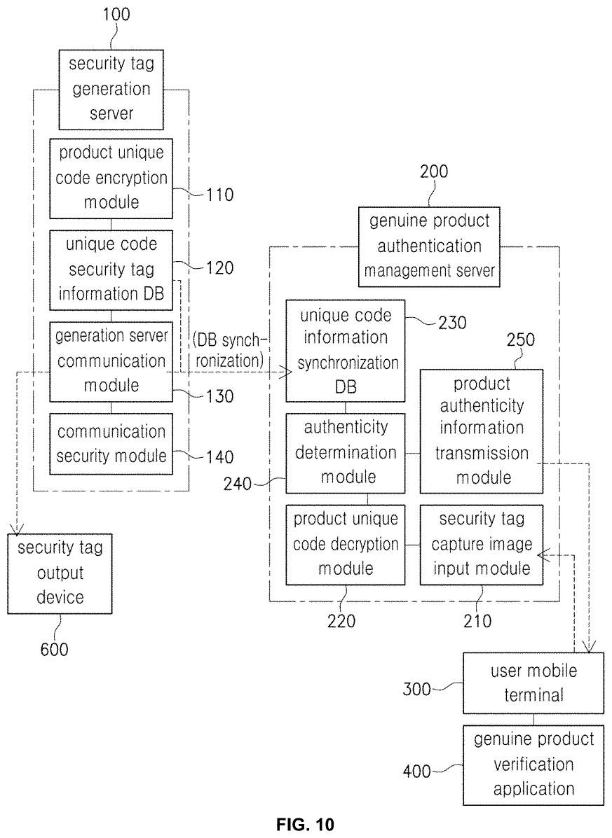

Here, the security tag generation server 100 according to an embodiment of the present invention is configured to include a product unique code encryption module 110, a unique code security tag information DB 120, a generation server communication module 130, and a communication security module 140, as shown in FIG. 10.

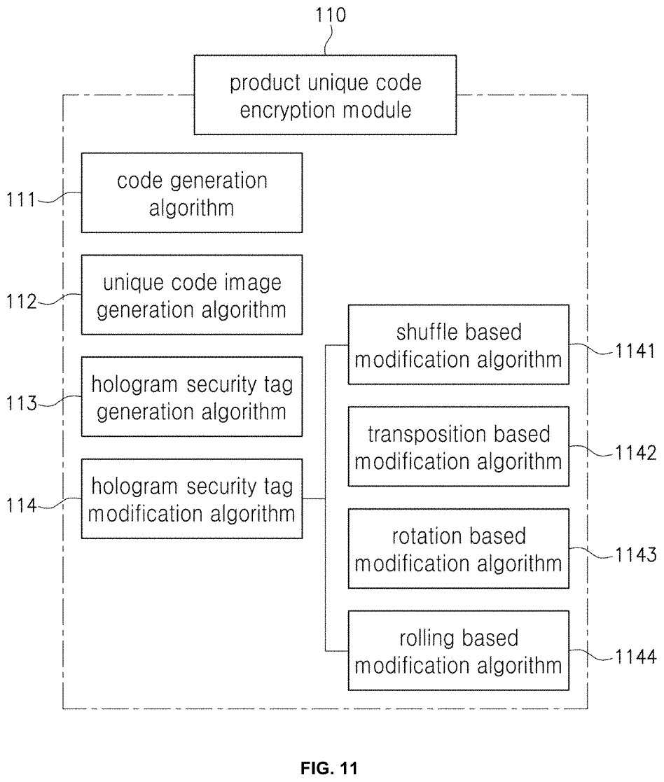

As shown in FIG. 11, the product unique code encryption module 110 stores a code generation algorithm 111 that generates a product unique code, a unique code image generation algorithm 112 that generates an unique code image from the unique code, a hologram security tag generation algorithm 113 that generates an original digital hologram security tag from the unique code image, and a hologram security tag modification algorithm 114 that converts the original digital hologram security tag into the modified digital hologram security tag. Accordingly, the product unique code encryption module 110 sequentially generates the unique code, the unique code image, the original digital hologram security tag, and the modified digital hologram security tag for the product that is subject to genuine product authentication.

Herein, the hologram security tag modification algorithm 114 may consist of any one selected from a shuffle based modification algorithm 1141, a transposition based modification algorithm 1142, a rotation based modification algorithm 1143, and a rolling based modification algorithm 1144, or a combination of two or more algorithms selected from the shuffle based modification algorithm 1141, the transposition based modification algorithm 1142, the rotation based modification algorithm 1143, and the rolling based modification algorithm 1144.

The shuffle based modification algorithm 1141 is an algorithm that generates a modified digital hologram security tag by randomly shuffling pixels located in a specific row or column in the original digital hologram security tag composed of multiple pixels.

The transposition based modification algorithm 1142 is an algorithm that generates a modified digital hologram security tag by symmetrically transposing positions of pixels spaced apart from each other by a predetermined distance in the original digital hologram security tag.

The rotation based modification algorithm 1143 is an algorithm that generates a modified digital hologram security tag by rotating pixels of a specific area in the original digital hologram security tag.

The rolling based modification algorithm 1144 is an algorithm that generates a modified digital hologram security tag by rotating pixels in a specific area by a predetermined angle clockwise or counterclockwise in the original digital hologram security tag.

The unique code-security tag information DB 120 is a DB in which the unique code, the unique code image, the original digital hologram security tag, and the modified digital hologram security tag are stored in association with product information.

The generation server communication module 130 outputs physical or electronic printings of the modified digital hologram security tag via wired/wireless communication with the security tag output device 600 in an offline environment, or performs a synchronization process for the stored information of the unique code-security tag information DB 120 via wired/wireless communication with the genuine product authentication management server 200. The product unique code information stored in a unique code information synchronization DB 230 of the genuine product authentication management server 200 through execution of the synchronization process is synchronized to the product unique code information stored in the unique code-security tag information DB 120 of the security tag generation server 100.

The communication security module 140 controls the activation of the generation server communication module 130, to allow the generation server communication module 130 to communicate with the outside only by a communication function activation signal of an administrator account. As such, when the generation server communication module 130 communicates with the outside, the communication security module 140 activates a firewall function.

In addition, the communication security module 140 allows the generation server communication module 130 not to communicate with the outside at a time other than a communication function activation time interval set by the administrator account. Accordingly, it is possible to enhance the security stability of the modified digital hologram security tag by blocking hacking attempts from the outside.

The genuine product authentication management server 200 is provided over a network, and receives the security tag capture image transmitted from the user mobile terminal 300 in conjunction with the genuine product verification application 400. The genuine product authentication management server 200 restores the received security tag capture image sequentially to the original digital hologram security tag and unique code image, determines whether the product is genuine by performing the process of comparing the restored unique code image with the unique code image stored in conjunction with the product information, and then transmits the product authenticity information to the user mobile terminal 300.

Herein, the genuine product authentication management server 200 according to an embodiment of the present invention, as shown in FIG. 10, is configured to include a security tag capture image input module 210, a product unique code decryption module 220, a unique code information synchronization DB 230, an authenticity determination module 240, a product authenticity information transmission module 250.

The security tag capture image input module 210 receives the security tag capture image received from the genuine product verification application 400 of the user mobile terminal 300, and then extracts the modified digital hologram security tag included in the security tag capture image.

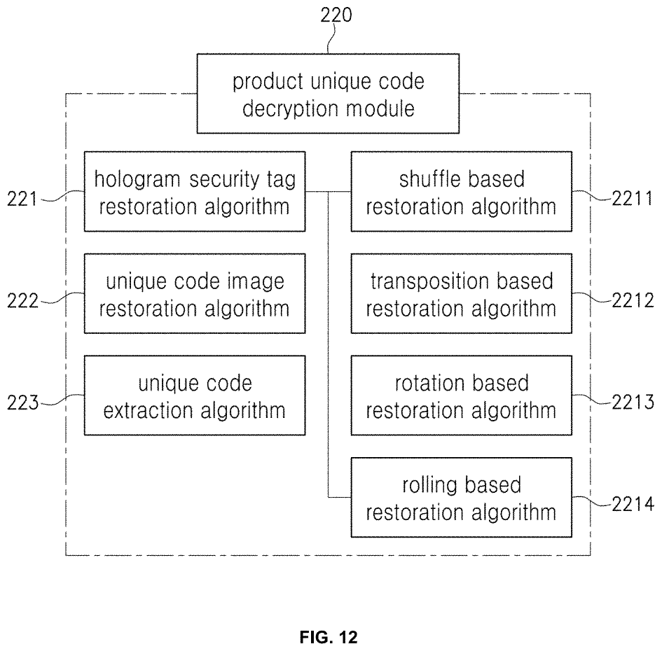

As shown in FIG. 12, the product unique code decryption module 220 is a module that stores a hologram security tag restoration algorithm 221 that restores the modified digital hologram security tag transmitted from the capture image input module 210 to the original digital hologram security tag, a unique code image restoration algorithm 222 that restores the original digital hologram security tag to a unique code image, and a unique code extraction algorithm 223 that extracts the unique code text information as a key value by performing processing, such as OCR, on the unique code image. Accordingly, the product unique code decryption module 220 restores the security tag capture image transmitted from the user mobile terminal 300 sequentially to the original digital hologram security tag, the unique code image, and the unique code text information.

Here, the hologram security tag restoration algorithm 221 may be any one selected from a shuffle based restoration algorithm 2211, a transposition based restoration algorithm 2212, a rotation based restoration algorithm 2213, and a rolling based restoration algorithm 2214, and a combination of two or more algorithms selected from the shuffle based restoration algorithm 2211, the transposition based restoration algorithm 2212, the rotation-based restoration algorithm 2213, and the rolling based restoration algorithm 2214.

The shuffle based restoration algorithm 2211 is an algorithm that restores the original digital hologram security tag from the modified digital hologram security tag by performing an information processing process of the shuffle based modification algorithm 1141 in reverse order thereof.

The transposition based restoration algorithm 2212 is an algorithm that restores the original digital hologram security tag from the modified digital hologram security tag by performing an information processing process of the transposition based modification algorithm 1142 in reverse order thereof.

The rotation based restoration algorithm 2213 is an algorithm that restores the original digital hologram security tag from the modified digital hologram security tag by performing an information processing process of the rotation based modification algorithm 1143 in reverse order thereof.

The rolling based restoration algorithm 2214 is an algorithm that restores the original digital hologram security tag from the modified digital hologram security tag by performing an information processing process of the rolling based modification algorithm 1144 in reverse order thereof.

The unique code information synchronization DB 230 is a DB in which unique codes associated with product information are stored in synchronization with the unique code-security tag information DB 120 of the security tag generation server 100.

The authenticity determination module 240 computes information indicating whether the product is genuine or not by determining whether the unique code text information transmitted from the product unique code decryption module 220 matches the unique code of the product stored in the unique code information synchronization DB 230. Here, the product authenticity information includes genuine product authentication information and genuine product non-authentication information.

The genuine product authentication information is generated when the unique code text information transmitted from the product unique code decryption module 220 matches the unique code of the corresponding product stored in the unique code information synchronization DB 230, and the genuine product non-authentication information is generated when the unique code text information transmitted from the product unique code decryption module 220 does not match the unique code of the corresponding product stored in the unique code information synchronization DB 230.

The product authenticity information transmission module 250 receives product authenticity information from the authenticity determination module 240 and transmits the same to the genuine product verification application 400 of the user mobile terminal 300.

The user mobile terminal 300 is possessed by a user, and may be a mobile communication terminal, a smart pad, a tablet PC, etc., or a dedicated authenticating terminal. The user mobile terminal 300 generates a security tag capture image by capturing a modified digital hologram security tag provided in a product distributed in an offline environment.

The genuine product verification application 400 is installed in the user mobile terminal 300. The genuine product verification application 400 manages the transmission of a security tag capture image and the reception of product authenticity information by wireless communication with the genuine product authentication management server 200, and output the product authenticity information.

Meanwhile, a digital hologram tag generator 500 for a computer-generated hologram based-genuine product authentication system according to an embodiment of the present invention is configured to include a unique code generation unit 510, a unique code image generation unit 520, an original digital hologram security tag generation unit 530, and a modified digital hologram security tag generation unit 540.

The unique code generation unit 510 is a unit that is provided with a code generation algorithm 111 to generate a unique code for a product that is subject to genuine product authentication.

The unique code image generation unit 520 is a unit that is provided with a unique code image generation algorithm 112 to generate a unique code image for the unique code.

The original digital hologram security tag generation unit 530 is provided with a hologram security tag generation algorithm 113 to generate an original digital hologram security tag from a unique code image.

The modified digital hologram security tag generation unit 540 is provided with a hologram security tag modification algorithm 114 to convert the original digital hologram security tag into the modified digital hologram security tag. Herein, the hologram security tag modification algorithm 114 includes any one selected from a shuffle based modification algorithm 1141, a transposition based modification algorithm 1142, a rotation based modification algorithm 1143, and a rolling based modification algorithm 1144, or includes a combination of two or more algorithms selected from the shuffle based modification algorithm 1141, the transposition based modification algorithm 1142, the rotation based modification algorithm 1143, and the rolling based modification algorithm 1144.

The shuffle based modification algorithm 1141 is an algorithm that generates a modified digital hologram security tag by randomly shuffling pixels located in a specific row or column in the original digital hologram security tag consisting of a plurality of pixels.

The transposition based modification algorithm 1142 is an algorithm that generates a modified digital hologram security tag by symmetrically transposing the positions of pixels that are spaced apart by a predetermined distance in the original digital hologram security tag.

The rotation based modification algorithm 1143 is an algorithm that generates a modified digital hologram security tag by rotating pixels of a specific area in the original digital hologram security tag.

The rolling based modification algorithm 1144 is an algorithm that generates a modified digital hologram security tag by rotating pixels in a specific area by a predetermined angle clockwise or counterclockwise in the original digital hologram security tag.

As described above, although the computer-generated hologram based-genuine product authentication method, the computer-generated hologram based-genuine product authentication system, and the digital hologram tag generator for a computer-generated hologram based-genuine product authentication system according to an embodiment of the present invention has been illustrated in the above description and drawings, the descriptions and drawings are merely examples, and those skilled in the art will appreciate that various changes and modifications are possible without departing from the spirit of the present invention.

What is claimed is:

1. A genuine product authentication method with enhanced security level of a digital hologram tag converted by a computer-generated hologram (CGH), the method comprising:
generating a product unique code and storing the same on a server;
generating a specific image file for a text of the product unique code stored in the server and storing the same in association with the product unique code;
extracting the specific image file stored in the server in association with the product unique code to convert the same into an original digital hologram security tag using the CGH, in a first CGH encryption step;
manipulating pixels in a specific area of the original digital hologram security tag converted through the first CGH encryption to convert the same into a modified digital hologram security tag, in a second CGH encryption step;
printing the modified digital hologram security tag converted through the second CGH encryption step to combine the same with the corresponding product;
capturing the modified digital hologram security tag of the product using a mobile communication terminal interworking with the server to transmit the same to the server;
restoring the pixels of the specific region that is manipulated in the modified digital hologram security tag transmitted through the server to convert the same to the original digital hologram security tag, in a first CGH decryption step;
restoring the original digital hologram security tag converted through the first CGH decryption step using the CGH to extract the specific image file, in a second CGH decryption step;
extracting unique code text information through OCR processing on the specific image extracted through the second CGH decryption step, to determine whether the unique code text information matches the product unique code stored in the server; and
transmitting a result of whether information on the modified digital hologram security tag combined with the product matches information on the corresponding product stored in the server to the mobile communication terminal.

2. The method of claim 1, wherein the second CGH encryption step includes any one of randomly shuffling pixels located in a specific row or column in the original digital hologram security tag, or transposing positions of pixels spaced apart by a predetermined distance from each other in the original digital hologram security tag, or rotating pixels of a specific area in the original digital hologram security tag, or rotating pixels of a specific area in the original digital hologram security tag by a predetermined angle clockwise or counterclockwise.

3. The method of claim 2, wherein the information is pre-stored in the server so that the second CGH encryption step and the first CGH decryption step are associated with each other for the product.

4. A computer-generated hologram based-genuine product authentication system, comprising:
a security tag generation server (100) sequentially generating a unique code, a unique code image, an original digital hologram security tag, and a modified digital hologram security tag for a product subject to genuine product authentication, storing the unique code, the unique code image, the original digital hologram security tag, and the modified digital hologram security tag in association with product information, and outputting physical or electronic printing of the modified digital hologram security tag through wired/wireless communication with a security tag output device (600) provided in an offline environment;
a genuine product authentication management server (200) restoring a security tag capture image received from the outside sequentially to the original digital hologram security tag and the unique code image, and performing an identity comparison process between the unique code image stored in association with the product information and the restored unique code image to determine a product authenticity, and generating information on the product authenticity to transmit the same to the outside;
a user mobile terminal (300) possessed by a user to capture the modified digital hologram security tag provided in a product distributed in an offline environment and generate the security tag capture image; and
a genuine product verification application (400) installed in the user mobile terminal (300) to manage transmission of the security tag capture image and reception of the product authenticity information by wireless communication with the genuine product authentication management server (200) and to output the product authenticity information.

5. The system of claim 4, wherein the security tag generation server (100) includes:
a product unique code encryption module (110) storing a code generation algorithm (111) that generates the product unique code, a unique code image generation algorithm (112) that generates the unique code image from the unique code, a hologram security tag generation algorithm (113) that generates the original digital hologram security tag from the unique code image, and a hologram security tag modification algorithm (114) that converts the original digital hologram security tag into the modified digital hologram security tag;
a unique code-security tag information DB (120) storing the unique code, the unique code image, the original digital hologram security tag, and the modified digital hologram security tag in association with the product information;
a generation server communication module (130) outputting a physical or electronic printing of the modified digital hologram security tag via wired/wireless communication with the security tag output device (600) provided in an offline environment, or performing a synchronization process for information stored in the unique code-security tag information DB (120) via wired/wireless communication with the genuine product authentication management server (200); and
a communication security module (140) controlling activation of the generation server communication module (130) to allow the generation server communication module (130) to communicate with the outside only by a communication function activation signal of an administrator account and allow the generation server communication module (130) not to communicate with the outside at a time other than a communication function activation time interval set by the administrator account, and activating a firewall function when the generation server communication module (130) communicates with the outside.

6. The system of claim 5, wherein the genuine product authentication management server (200) includes:
a security tag capture image input module (210) receiving the security tag capture image received from the genuine product verification application (400) of the user mobile terminal 300, and extracting the modified digital hologram security tag included in the security tag capture image;
a product unique code decryption module (220) storing a hologram security tag restoration algorithm (221) that restores the modified digital hologram security tag transmitted from the captured image input module (210) to the original digital hologram security tag, a unique code image restoration algorithm (222) that restores the original digital hologram security tag to a unique code image, and a unique code extraction algorithm (223) that extracts the unique code text information as a key value by performing OCR processing on the unique code image;
a unique code information synchronization DB (230) storing the unique code associated with the product information in synchronization with the unique code-security tag information DB (120) of the security tag generation server (100);
an authenticity determination module (240) determining information indicating whether the product is genuine or not by determining whether the unique code text information transmitted from the product unique code decryption module (220) matches the product unique code stored in the unique code information synchronization DB (230), the product authenticity information including genuine product authentication information generated when the unique code text information matches the product unique code of the stored in the unique code information synchronization DB (230), and genuine product non-authentication information generated when the unique code text information does not match the product unique code stored in the unique code information synchronization DB (230); and
a product authenticity information transmission module (250) receiving product authenticity information from the authenticity determination module (240) and transmits the same to the genuine product verification application (400) of the user mobile terminal (300).

7. The system of claim 6, wherein the hologram security tag modification algorithm (114) of the product unique code encryption module (110) includes at least one algorithm selected from:
a shuffle based modification algorithm (1141) generating the modified digital hologram security tag by randomly shuffling pixels located in a specific row or column in the original digital hologram security tag consisting of multiple pixels;
a transposition based modification algorithm (1142) generating the modified digital hologram security tag by symmetrically transposing positions of pixels spaced apart from each other by a predetermined distance in the original digital hologram security tag;
a rotation based modification algorithm (1143) generating a modified digital hologram security tag by rotating pixels of a specific area in the original digital hologram security tag; and
a rolling based modification algorithm (1144) generating a modified digital hologram security tag by rotating pixels in a specific area by a predetermined angle clockwise or counterclockwise in the original digital hologram security tag, and the hologram security tag restoration algorithm (221) of the product unique code decryption module (220) includes at least one of:
a shuffle based restoration algorithm (2211) restoring the original digital hologram security tag from the modified digital hologram security tag by performing an information processing process of the shuffle based modification algorithm (1141) in reverse order thereof;
a transposition based restoration algorithm (2212) restoring the original digital hologram security tag from the modified digital hologram security tag by performing an information processing process of the transposition based modification algorithm (1142) in reverse order thereof;
a rotation based restoration algorithm (2213) restoring the original digital hologram security tag from the modified digital hologram security tag by performing an information processing process of the rotation based modification algorithm (1143 in reverse order thereof; and
a rolling based restoration algorithm (2214) restoring the original digital hologram security tag from the modified digital hologram security tag by performing an information processing process of the rolling based modification algorithm (1144) in reverse order thereof.

8. A digital hologram tag generator for a computer-generated hologram based-genuine product authentication system, the generator comprising:
a unique code generation unit (510) provided with a code generation algorithm (111) to generate a unique code for a product that is subject to genuine product authentication;
a unique code image generation unit (520) provided with a unique code image generation algorithm (112) to generate a unique code image for the unique code;
an original digital hologram security tag generation unit (530) provided with a hologram security tag generation algorithm (113) to generate an original digital hologram security tag from the unique code image; and
a modified digital hologram security tag generation unit (540) provided with a hologram security tag modification algorithm (114) to convert the original digital hologram security tag into a modified digital hologram security tag,
wherein the hologram security tag modification algorithm (114) including at least one of:
a shuffle based modification algorithm (1141) generating the modified digital hologram security tag by randomly shuffling pixels located in a specific row or column in the original digital hologram security tag consisting of multiple pixels;
a transposition based modification algorithm (1142) generating the modified digital hologram security tag by symmetrically transposing positions of pixels spaced apart from each other by a predetermined distance in the original digital hologram security tag;
a rotation based modification algorithm (1143) generating the modified digital hologram security tag by rotating pixels of a specific area in the original digital hologram security tag; and
a rolling based modification algorithm (1144) generating the modified digital hologram security tag by rolling pixels in a specific area by a predetermined angle clockwise or counterclockwise in the original digital hologram security tag.
